(19) United States
(12) Patent Application Publication
(10) Pub. No.: US 2019/0090052 A1
(43) Pub. Date: Mar. 21, 2019

(54) COST EFFECTIVE MICROPHONE ARRAY DESIGN FOR SPATIAL FILTERING

(71) Applicant: Knowles Electronics, LLC, Itasca, IL (US)

(72) Inventors: Nasim Radmanesh, Itasca, IL (US); Sharon Gadonniex, Itasca, IL (US)

(73) Assignee: Knowles Electronics, LLC, Itasca, IL (US)

(21) Appl. No.: 16/133,332

(22) Filed: Sep. 17, 2018

Related U.S. Application Data
(60) Provisional application No. 62/560,866, filed on Sep. 20, 2017.

(51) Int. Cl. H04R 1/40; H04R 3/00

(52) U.S. Cl. CPC H04R 1/406; H04R 2430/21; H04R 3/005

(57) ABSTRACT

An audio system includes an array of microphones and an audio processing system. The array of microphones includes a plurality of microphones configured to record a plurality of sound signals based on sound waves emanating from a sound source. The audio processing system includes a direction of arrival (DOA) estimator configured to generate an estimation of a DOA of the sound waves emanating from the sound source based on the plurality of sound signals, a statistical subset selector configured to select a subset of the plurality of microphones based on the estimation of the DOA, and a spatial filter configured to modify and combine a set of sound signals associated with the selected subset of the plurality of microphones to produce an audio output associated with the sound source.

### CROSS-REFERENCE TO RELATED APPLICATIONS

This application claims the benefit of and priority to U.S. Provisional Patent Application No. 62/560,866, filed Sep. 20, 2017, the entire contents of which are incorporated herein by reference.

### BACKGROUND

Audio systems often operate in noisy environments. In addition to a desired sound signal (e.g., a speech signal) there may be many other competing sources of sound that may drown out the desired sound signal. To provide an intelligible output of the desired sound signal, it is necessary to extract the desired sound signal while minimizing the undesired competing sound sources. Accordingly, many audio systems employ multi-microphone arrays and signal processors to isolate the desired sound signal. These signal processors may utilize a beamforming technique to spatially filter incoming sound signals to selectively enhance the desired sound signal.

### SUMMARY OF THE INVENTION

One embodiment relates to an audio device. The audio device includes an array of microphones comprising a plurality of microphones configured to record a plurality of sound signals based on sound waves emanating from a number of sound sources. The audio device also includes an audio processing system. The audio processing system includes a direction of arrival (DOA) estimator configured to generate an estimation of a DOA of the sound waves emanating from the desired sound source based on the plurality of sound signals, a statistical subset selector configured to select a subset of the plurality of microphones based on the estimation of the DOA, and a spatial filter configured to modify and combine a set of sound signals associated with the selected subset of the plurality of microphones to produce an audio output associated with the sound source.

Another embodiment relates to a method of generating an audio output signal. The method includes generating, by a microphone array associated with an audio device, a plurality of sound signals. The method also includes estimating, by an audio processing system coupled to the microphone array, a direction of arrival (DOA) of sounds emanating from a sound source. The method also includes selecting, by the audio processing system, a subset of microphones of the microphone array based on the estimated DOA. The method also includes providing, by the audio processing system, sound signals associated with the selected subset to a spatial filtering circuit to generate weights for each of the subset of microphones. The method also includes combining, by the audio processing system, the weighted sound signals to generate an enhanced audio output.

### BRIEF DESCRIPTION OF THE DRAWINGS

FIG. 1 is a block diagram of an environment of an audio device, according to an example embodiment.

FIG. 2 is a more detailed view of the audio device of FIG. 1, according to an example embodiment.

FIG. 3 is a more detailed view of an audio processing system of the audio device shown in FIG. 1, according to an example embodiment.

FIG. 4 is a view of an audio processing system, according to an example embodiment.

FIG. 5 is a block diagram of a spatial filtering circuit, according to an example embodiment.

FIG. 6 is a flow diagram of a method of generating an enhanced audio output using a subset of microphones from a microphone array, according to an example embodiment.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

The present disclosure relates to systems and methods enabling cost effective spatial filtering to selectively enhance sounds emanating from a desired source. A first aspect of the present disclosure relates to an audio system including a microphone array having a number of different microphones configured to generate sound signals based on sounds received from various audio sources. For example, in one embodiment, the microphone array includes n microphones. The audio system also includes a number of multiplexers. In one embodiment, the audio system includes m multiplexers, where m is less than n. Each multiplexer is coupled to at least two microphones in the microphone array, and is associated with a data analysis channel configured to provide a selected sound signal to processing circuitry for further processing. Each data analysis channel may include components (e.g., analog-to-digital converters, amplifiers, etc.) configured to condition the selected sound signal for processing. Through incorporation of the multiplexers, the number of data analysis channels employed in the audio system is less than the number of microphones. As such, the configuration of the audio system disclosed herein reduces the components necessary to condition sound signals produced by each microphone, thereby reducing hardware costs.

In another aspect, the processing circuitry of the audio device is configured to spatially filter the sound signals recorded by the microphones in the microphone array. Accordingly, the processing circuitry is configured to assign weights to sound signals recorded by the microphone array and combine the sound signals so as to selectively enhance sounds emanating from a desired source and diminish sounds emanating from interfering sources. Rather than combining sound signals generated by each of the microphones in the microphone array, however, the processing circuitry is configured to select a subset of the microphones to combine to produce a spatially filtered output. Accordingly, the processing circuitry employs includes a statistical subset selection circuit structured to cause the processing circuitry to choose the subset of microphones. In one embodiment, the processing circuitry utilizes a least absolute shrinkage and selection operator (LASSO) to select the subset of microphones based on an estimated direction of arrival (DOA) of a desired sound. In one embodiment, the selected subset of microphones is no more than m. Accordingly, upon selection of the subset of microphones, the processing circuitry may identify addresses at the multiplexers associated with the selected subset of microphones, thereby providing only sound signals generated recorded by the selected subset of microphones to a spatial filtering circuit.

Limiting the number of sound signals employed in spatial filtering facilitates the utilization of a limited number of data analysis channels. Additionally, selection of the subset of microphones based on the direction of arrival of a desired sound may produce a larger signal-to-noise ratio (SNR) than when a regularly spaced microphone array of the same size is controlled to produce an output. As such, the systems and methods disclosed herein provide both reduced hardware costs and better performance over current systems.

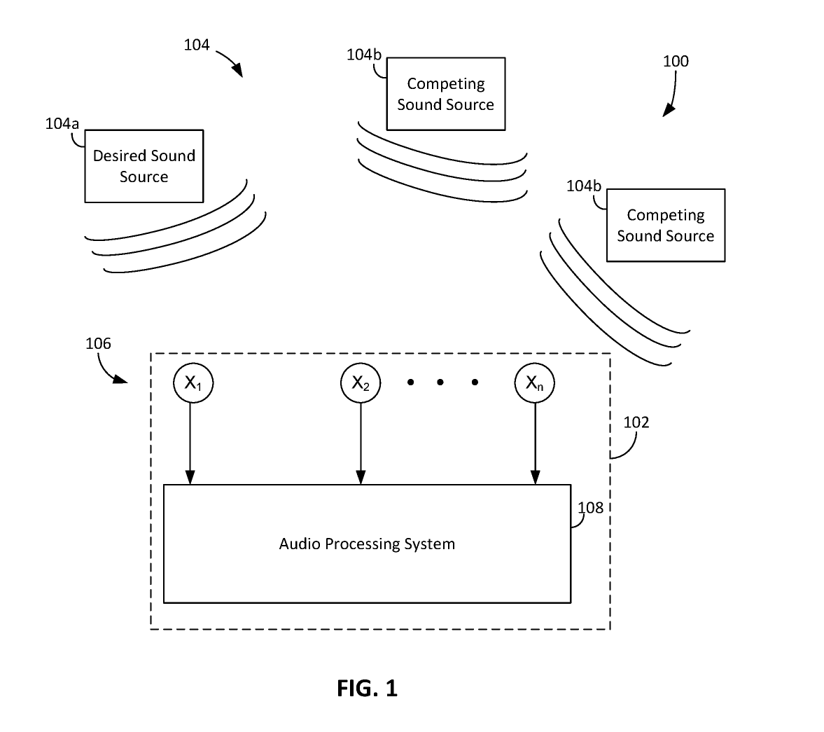

Referring now to FIG. 1, a block diagram of an example environment 100 in which the embodiments of the present technology can be practiced is shown, according to an example embodiment. As shown, the environment 100 includes an audio device 102 and sound sources 104. Sound sources 104 include a desired sound source 104a and competing sound sources 104b. In various embodiments, a goal of the audio device 102 is to selectively enhance sounds emanating from the desired sound source 104a so as to produce a desired sound output for any desired application (e.g., a speech recognition circuit).

The audio device 102 includes a microphone array 106 and an audio processing system 108. As shown, the microphone array 106 includes n microphones (X₁, X₂, . . . , and Xₙ). In an example embodiment, the microphone array includes sixteen microphones. In various embodiments, the microphones X₁, X₂, . . . , and Xₙ may be arranged in any configuration depending upon the application or form factor of a system in which the array 106 and/or audio device 102 is incorporated. For example, in one embodiment where the audio device 102 is a voice recognition system for a mobile phone, the microphones X₁, X₂, . . . , and Xₙ are arranged in a circular arrangement, with each of the microphones X₁, X₂, . . . , and Xₙ being evenly distributed around a circumference of a circle. In another example, the microphones X₁, X₂, . . . , and Xₙ are arranged linearly.

Each of the microphones X₁, X₂, . . . , and Xₙ may be an omnidirectional microphone. Given the presence of both the desired sound source 104a and the competing sound sources 104b in the environment 100, each of the microphones X₁, X₂, . . . , and Xₙ records a sound signal that represents a combination of sound waves received from the various sound sources 104. Thus, to provide an output that corresponds to the desired sound source 104a, it is necessary to filter the sound signals recorded by the microphones X₁, X₂, . . . , and Xₙ. In this regard, the audio processing system 108 processes the sound signals received by the microphones X₁, X₂, . . . , and Xₙ via a spatial-temporal filtering process such as beamforming.

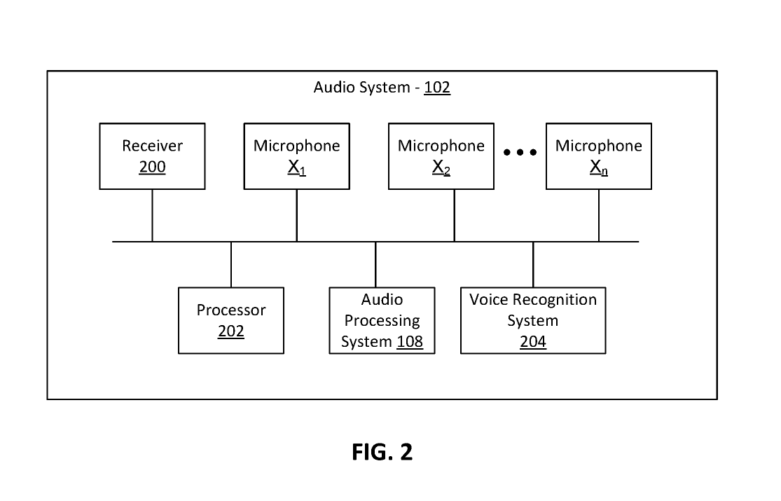

Referring now to FIG. 2, a block diagram of an example audio device 102 is shown. In the illustrated embodiment, the audio device 102 includes a receiver 200, a processor 202, microphones X₁, X₂, . . . , and Xₙ, the audio processing system 108, and a voice recognition system 204. The audio device 102 may include additional or different components to enable additional operations. Similarly, the audio device 102 may include fewer components that perform similar or equivalent functions to those depicted in FIG. 2.

Processor 202 may execute instructions and circuits stored in a memory (not illustrated in FIG. 2) of the audio device 102 to perform functionality described herein. Processor 202 may include hardware and software implemented as a processing unit, which may process floating point and/or fixed-point operations and other operations for the processor 202. The receiver 200 may include a network communications interface configured to receive and transmit signals over a network via any established communications protocol. The audio processing system 108 may provide a processed signal to the voice recognition system 204. In alternative embodiments, the processed signal may be provided to a device for providing an audio output to a user (e.g., a speaker) or a memory of the audio device 102, where the processed signal is stored for later use.

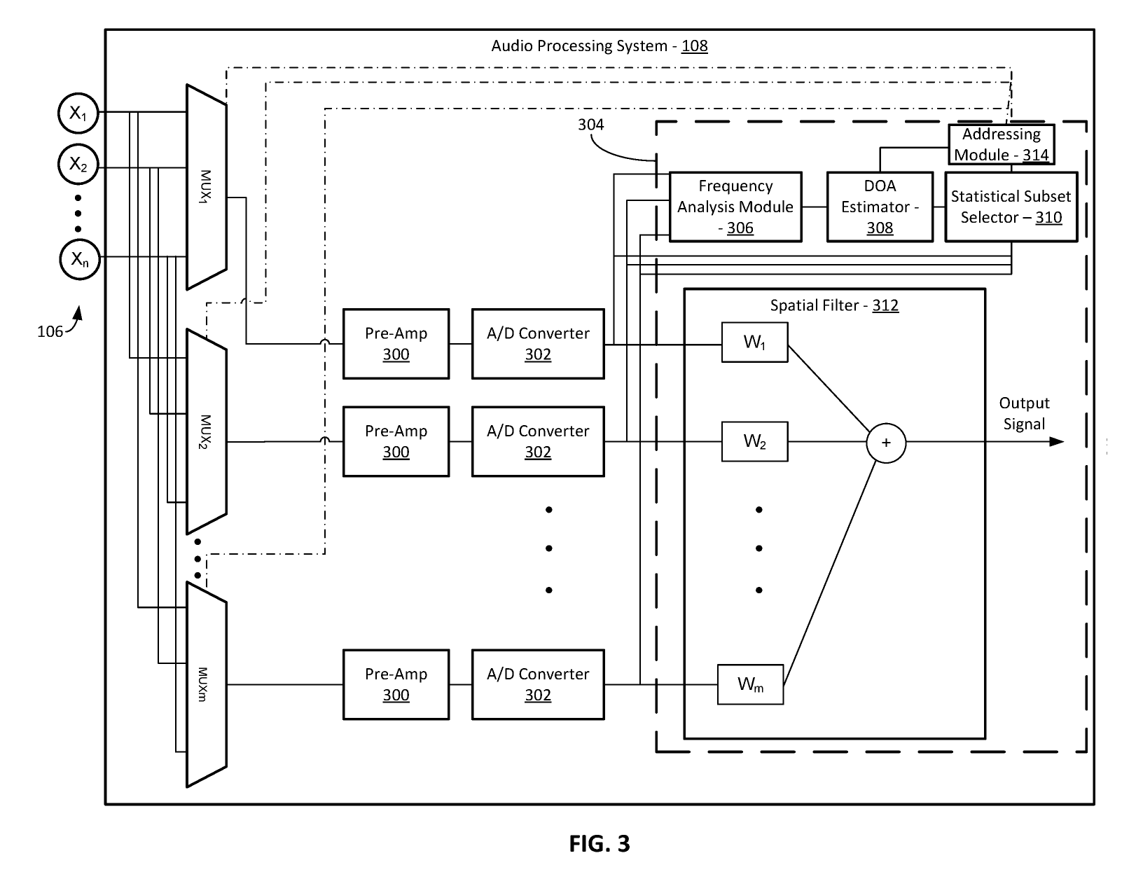

As described herein, the audio processing system 108 is configured to receive sound signals that represent sounds received via the microphones X₁, X₂, . . . , and Xₙ and process the sound signals. For example, as described with respect to FIG. 3, the audio processing system 108 is configured to estimate a DOA of sound emanating from a desired sound source and, based on the DOA, selectively eliminate a subset of the microphones X₁, X₂, . . . , and Xₙ from which to produce an output. The sounds signals recorded via the remaining microphones X₁, X₂, . . . , and Xₙ are combined using weights generated by the audio processing system 108 to provide an enhanced output to the voice recognition system 204.

Referring now to FIG. 3, block diagram of an audio processing system is shown, according to an example embodiment. The block diagram of FIG. 3 may provide additional details of the audio processing system 108 shown in FIGS. 1 and 2. Audio processing system 108 in this example includes m multiplexers MUX₁, MUX₂, . . . , and MUXₘ, amplifiers 300, analogue-to-digital converters 302, and an analysis circuit 304. In various embodiments, the number of multiplexers m is less than the number of microphones n in the microphone array 106. For example, in one embodiment, the microphone array 106 includes 16 microphones and the audio processing system 108 includes eight multiplexers.

The multiplexers MUX₁, MUX₂, . . . , and MUXₘ may either be analog or digital. In the example shown, each of the multiplexers MUX₁, MUX₂, . . . , and MUXₘ includes a number of input lines that corresponds to the number of microphones n in the microphone array 106. In such an embodiment, each of the microphones in the microphone array 106 is coupled to each of the multiplexers via the input lines. It should be understood that alternative configurations are possible. In some embodiments, each of the multiplexers MUX₁, MUX₂, . . . , and MUXₘ includes a number of input lines that is less than n and each multiplexer is connected to only a subset of the microphones. For example, in one embodiment, each multiplexer is coupled to a subset of microphones that are adjacent to one another in the configuration of the microphone array 106. In some embodiments, the multiplexers MUX₁, MUX₂, . . . , and MUXₘ include different numbers of input lines.

Each of the multiplexers MUX₁, MUX₂, . . . , and MUXₘ also include a number of select lines. For example, in various embodiments, each multiplexer may include 2^{b} input lines and b select lines. Such select lines may be placed in different states to select a particular input line to convey to the output. For example, addresses may be relayed to each of the multiplexers via the analysis circuit 304 to selectively provide inputs from only a subset of the microphones to the additional elements of the audio processing system 108. The selected output from each of the multiplexers is provided to amplifiers 300 and analog-to-digital converters 302 to enable the input sound signals to be processed via the analysis circuit 304.

The analysis circuit 304 is configured to perform multiple operations on the data received via the multiplexers to provide an output audio signal. In a first set of operations, the analysis circuit 304 is configured to cause the audio processing system 108 to select a set of sound signals to perform spatial filtering on to provide an output signal. In this regard, the analysis circuit 304 includes a frequency analysis circuit 306, a DOA estimator 308, and a statistical subset selector 310.

The frequency analysis circuit 306 separates received signals into frequency sub-bands. A sub-band is the result of a filtering operation on an input signal where the bandwidth of the filter is narrower than the bandwidth of the signal received by the frequency analysis circuit 306. Alternatively, other filters such as short-time Fourier transform (STFT), sub-band filter banks, modulated complex lapped transforms, cochlear models, wavelets, etc., can be used for the frequency analysis. As a result, intervals (e.g., frames) of the sound signals received via the multiplexers are converted into frequency band subcomponents.

The DOA estimator 308 is configured to estimate the direction of arrival of sounds emanating from a desired sound source based on the various sound signals recorded via the microphones of the microphone array 106. In some embodiments, the direction of arrival estimator 308 only utilizes a subset of sound signals recorded via the microphone array 106 to estimate the DOA. The subset of sound signals utilized may be dependent on the geometry of the microphone array 106. For example, in an embodiment where the microphone array 106 includes a circular or linear arrangement of microphones, the DOA estimator 308 may use half of the microphones in the microphone array 106 (e.g., every other microphone).

Accordingly, to implement the DOA estimator 308, the audio processing system 108 may selectively provide sounds signals recorded by a subset of microphones in the microphone array 106 to the DOA estimator 308. For example, the audio processing system 108 may cycle through sets of addresses of each multiplexer to provide a subset of sound signals for estimating the DOA. In some implementations, where, for example, the number of microphones used in estimating the DOA equals the number of multiplexers m, only a single input line from each multiplexer is used to provide a sound signal input for the DOA estimator 308. In other implementations, where the number of microphones used in estimating the DOA is greater than the number of multiplexers, the audio processing system 108 cycles through a set of addresses of each multiplexer to provide a number of sound singles to the DOA estimator 308. Such address cycling causes a time delay between the sound signals provided to the DOA estimator 308 from each multiplexer. Accordingly, in such implementations, the analysis circuit 304 includes a time-matching filter configured to match the timing of each of the sound signals provided to the DOA estimator 308. Thus, after the time-matching filter, a plurality of time-matched sound signals recorded by a selected set of microphones of the microphone array 106 are separated into a number of frequency subcomponents and used to estimate the DOA of sounds incident on the microphone array 106.

The DOA estimator 308 performs various operations on the time-matched input data to estimate DOAs of the incident sound within various frequency bands. The DOA estimator 308 may utilize any method to estimate the DOA of the sounds from the sound sources 104 incident on the microphone array 106. For example, in one embodiment, the DOA estimator 308 may estimate the spatial correlation matrix of the input signals from a number of the microphones of the microphone array 106 and perform an Eigen analysis of the spatial correlation matrix to obtain a set of DOA estimates. These DOA estimates may then be used to assign weights to each of the subset of microphones used in the DOA estimation. For example, any beamforming algorithm may be used to assign weights to the each of the subset of microphones used in the DOA estimation based on the DOA estimate. In some embodiments, for example, the particular beamforming algorithm selected depends on the geometry of the microphone array 106. Once the weights are assigned, a weighted summation of each of the sound signals used in the DOA estimation may then be performed to produce an enhanced observation signal Y_{Θ}for use in selecting another subset of microphones to be used to generate a final output signal, as described herein.

The statistical subset selector 310 is configured to identify a subset of microphones in the microphone array 106 that is highly correlated with the observation signal Y_{Θ}. In various embodiments, the statistical subset selector 310 is configured to receive signals recorded by each of the microphones in the microphone array 106 as an input and identify a subset of microphones as an output. In this regard, the statistical subset selector 310 may employ a statistical algorithm that assigns zero weights to a portion of the microphones in the microphone array 106. The other microphones (i.e., those assigned non-zero weights) form the selected subset of microphones.

In various embodiments, to select a subset of microphones from which to construct an output signal, the statistical subset selector 310 employs a least absolute shrinkage selection operator (LASSO). Such an operator may be summarized as follows. Given a set of m desired signals yᵢ, the LASSO seeks to select a set of weights w_{i,j} based on a set of n explanatory variables xⱼ (e.g., the transfer function between the sound sources 104 and the microphones X₁, X₂, . . . , and Xₙ) that satisfy the following relationship:

[symbol]

:=_{w}_{_{i,j}}^{arg min}[½∥XⱼW_{i,j}−y_{i,j}∥₂²+λ∥W_{i,j}∥₁] (1)

where λ is a penalization factor. Such a relationship represents a convex optimization problem and may be solved through any number of methods. The solution of such a problem using the LASSO operator results in a number of zero weights and a number of non-zero weights. Accordingly, the non-zero weights correspond to the selected subset of microphones.

The larger the value that the penalization factor λ takes, the fewer nonzero weights will result from providing a solution to the relationship (1). In some embodiments, the statistical subset selector 310 employs a coordinate descent method to generate a set of nonzero weights that satisfies the relationship (1) above. In such a method, for a particular value of λ, an initial set of weights is chosen at random, or a set of weights is chosen to equal the number of desired signals yᵢ. The statistical subset selector 310 then cyclically adjusts each of the weights from the initial values one at a time. In other words, one weight is adjusted based on the value of the gradient of the relationship (1) with respect to that weight while the others are held fixed. Such a process is repeated with respect to each of the weights until a convergent solution emerges. Various of sets of weights are generated in such a manner for every value of λ until a set of weights having predetermined characteristics is found. For example, in one embodiment, the statistical subset selector 310 may select a solution wherein the number of weights is below a threshold value (e.g., the number of multiplexers of the audio processing system 108). In various embodiments, the chosen solution may vary depending on the configuration of the microphone array 106 and the audio processing system 108.

In various embodiments, the statistical subset selector 310 performs the above-described process for each frequency subcomponent of the sound signals generated by the microphone array 106. As such, for each frequency subcomponent, the statistical subset selector 310 may generate a different set of non-zero weights corresponding to different sets of microphones in the microphone array 106. The statistical subset selector 310 may select the union of all such sets to identify a final set of microphones. In some embodiments, if the union of the subsets associated with the frequency subcomponents does not meet predetermined criteria (e.g., the number of microphones in the union set is smaller or larger than the number of data analysis channels), the statistical subset selector 310 may re-perform the selection process using a different set of criteria (e.g., using different values for the penalty parameter λ).

Having selected a set of microphones, the audio processing system 108 provides set of addresses to the multiplexers so as to provide sound signals generated by the selected set of microphones to the spatial filtering circuit 312. In this regard, audio processing system may include an addressing circuit 314. The addressing circuit 314 is configured to receive a selected set of microphones generated by the statistical subset selector 310 as an input and produce sets of addresses for each of the multiplexers as an output. The addressing circuit 314 may include a multiplexer address selection mapper. The multiplexer address selection mapper may assign each of the microphones corresponding to the nonzero weights to a particular multiplexer, and include various lookup tables mapping the addresses of the multiplexers to the microphones of the microphone array 106. Accordingly, after a particular microphone is assigned to a particular multiplexer, an addressing signal may be provided to that particular multiplexer so as to couple the selected microphone to the spatial filtering circuit 312. Additionally, the addressing circuit 314 may include sets of addresses corresponding to the microphones used by the DOA estimator 308 to generate the DOA estimate. As such, the addressing circuit 314 may switch between addressing schemes depending on whether the DOA estimator 308 or spatial filtering circuit 312 is being executed.

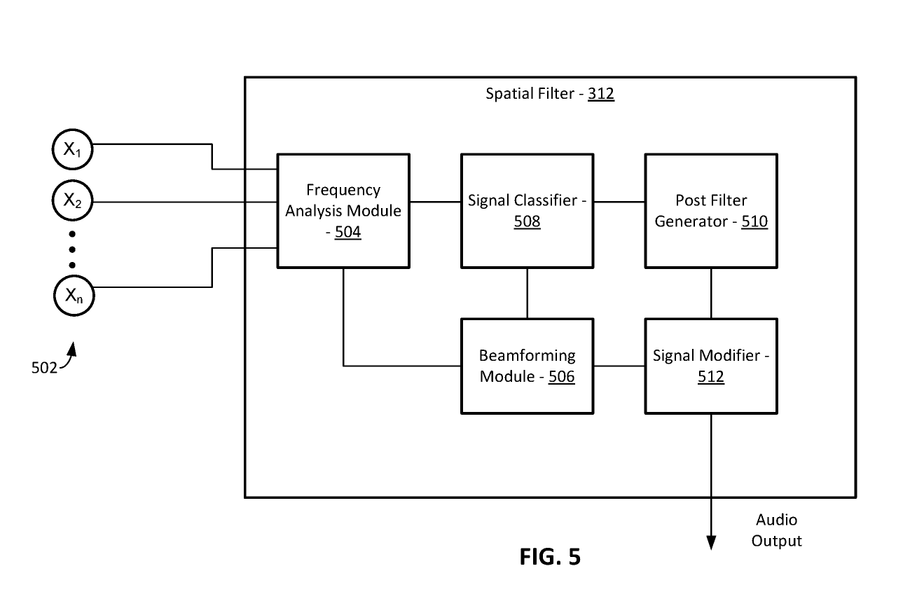

The spatial filtering circuit 312 is configured to generate a set of weights for each of the microphones selected via the process described herein and combine the weighted signals to generate a selectively enhanced audio output that may be used for any application. The spatial filtering circuit 312 may utilize any method (e.g., data independent or statistically optimized beamforming) to generate a set of weights to be applied to the selected subset of microphones. The weights are then applied to each of the selected signals, which are then combined to produce an audio output. An example spatial filtering circuit 312 will be described with respect to FIG. 5.

In various embodiments, the DOA estimator 308 periodically updates the DOA estimate, re-triggering execution of the statistical subset selector 310 to update the selected subset of microphones from the microphone array 106. As such, the audio processing system 108 may periodically switch the addressing signals provided to the multiplexers so as to change the optimal set of microphones to achieve the highest SNR. An example implementation may be described as follows. The audio processing system 108 may sample sound signals generated by a predetermined subset of the microphones of the microphone array 106 (e.g., based on the geometry of the microphone array 106) at a first instant in time, and execute the DOA estimator 308 and statistical subset selector 310 to select a subset of the microphones to utilize to generate the output signal. Next, for a predetermined period, addressing signals are provided to the multiplexers that correspond to the selected subset to provide signals corresponding to the selected subset to the spatial filtering circuit 312. After the expiration of the predetermined period, the addressing signals are changed to correspond to the predetermined subset for re-execution of the DOA estimator 308 and statistical subset selector 310 to update the selected subset of microphones. Thus, the systems and methods disclosed herein enable real-time updating of microphone selection to respond to changes in the relative positioning between the audio device 102 and the desired sound source 104a.

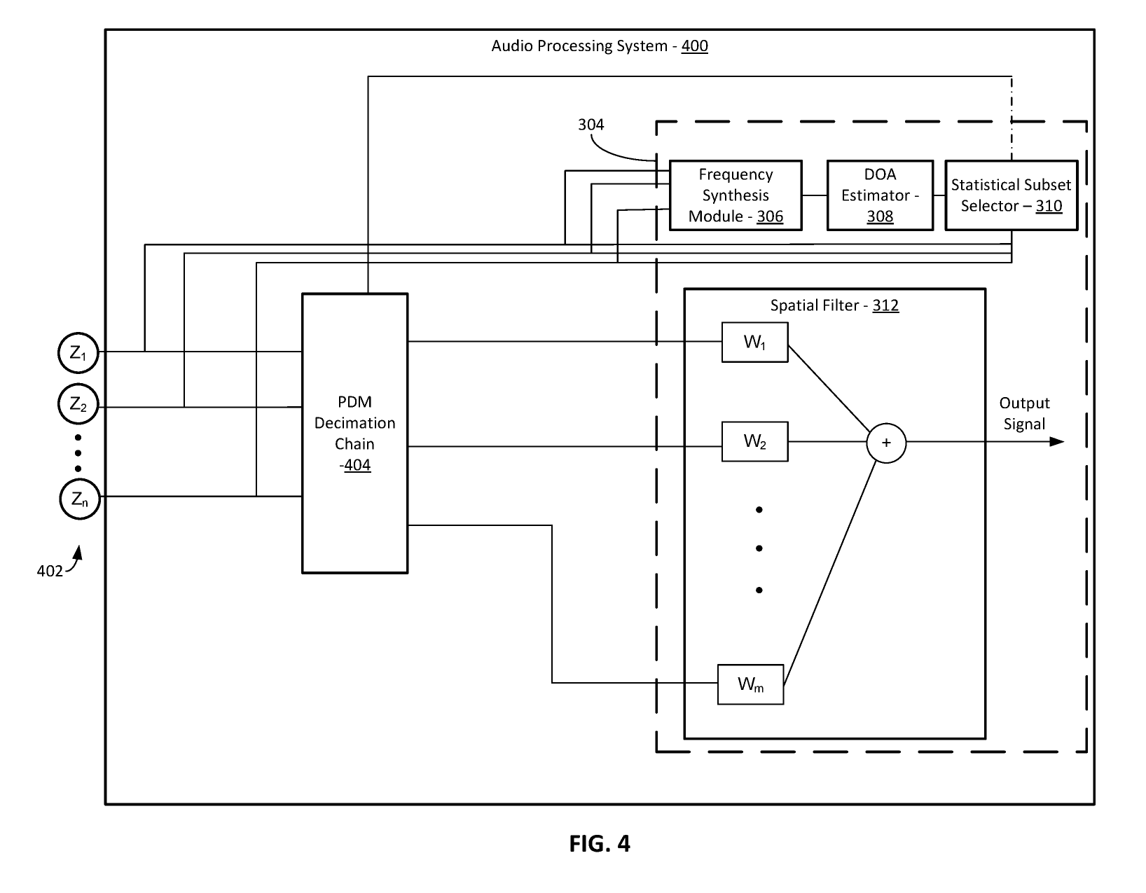

Referring now to FIG. 4, an alternative audio processing system 400 is shown, according to an example embodiment. The audio processing system 400 shares many of the same features as the audio processing system 108 described with respect to FIGS. 1-3. Accordingly, like reference numerals may be used to refer to such like components. The audio processing system 400 differs from the audio processing system 108 in that the audio processing system 400 is coupled to a microphone array 402 that includes digital microphones Z₁, Z₂, . . . Zₙ instead of the analog microphones X₁, X₂, . . . Xₙ described with respect to FIGS. 1-3. Digital microphones Z₁, Z₂, . . . Zₙ include, for example, pulse width modulators and provide streams of single bit signals to the audio processing system 400.

As such, instead of including a set of multiplexers, the audio processing system 400 includes a decimation chain filter 404 that selectively provides signals recorded by the microphone array 402 to the spatial filtering circuit 312. Accordingly, rather than providing a set of multiplexer addresses, the statistical subset selector 310 is configured to modify the rate at which the signals from the microphone array 402 are sampled. In an example where the microphone array 402 includes a set of sixteen microphones, the statistical subset selector 310 may select a subset of eight of the microphones, and adjust the sampling rate via the decimation chain filter 404 such that the net sampling rate is half of that provided to the DOA estimator 308. As such, only signals generated by half of the microphones Z₁, Z₂, . . . Zₙ (i.e., those corresponding to the half having non-zero coefficients associated therewith) are provided to the spatial filtering circuit 312.

It should be understood that alternative audio processing systems are envisioned. For example, in one embodiment, a hybrid audio processing system is coupled to a microphone array including both analog and digital microphones. In such an implementation, the hybrid audio processing system may include both a set of multiplexers (connected to the array of analog microphones) and a decimation filter (connected to the array of digital microphones). It should be understood that the systems and methods disclosed herein are suitable for use with any combination of microphones.

Referring now to FIG. 5, a block diagram of the spatial filtering circuit 312 is shown, according to an example embodiment. The spatial filtering circuit 312 is configured to modify and combine the sound signals generated by a selected subset of microphones 502 (e.g., of the microphone array 106). As shown, the spatial filtering circuit 312 includes a frequency analysis circuit 504, a beamforming circuit 506, a signal classifier 508, a post filter generator 510, and a signal modifier 512. Similar to the frequency analysis circuit 306 described with respect to FIG. 3, the frequency analysis circuit 504 is configured to convert the signals from the selected subset of microphones 502 into a number of frequency subcomponents.

The beamforming circuit 506 is configured to generate a set of weights to be applied to the active microphone sound signals to enhance the sound signal emanating from the desired sound source 104a. In various embodiments, the beamforming circuit 506 employs an algorithm to generate a set of weights corresponding to different frequency bins. For example, in one embodiment, tan initial set of weights is computed and adjusted to minimize the mean squared error between the output of the beamforming circuit 506 (i.e., the weighted combination of the subset of microphone signals 502) and a reference signal. In some embodiments, the reference signal corresponds to a signal recorded by the active set of microphones 502 that is classified by the signal classifier 508 as emanating from the desired sound source 104a (e.g., classified as speech).

The signal classifier 508 is configured to classify components of the sound signals generated via the selected set of microphones 502 into components emanating from the desired sound source 104a and the competing sound sources 104b (e.g., into speech components and noise components). For example, in some embodiments, such a classification is performed based on measured energy level differences and correlations between respective sound signals generated via each of the selected set of microphones 502. From these classifications, the signal classifier 508 may generate estimations of the energy spectra of the speech and noise components, and estimate the signal-to-noise ratio associated with each of the selected set of microphones 502. The signal classifier 508 may operate in a manner similar to that described in U.S. Pat. No. 8,473,287 entitled “Method for Jointly Optimizing Noise Reduction and Voice Quality in a Mono or Multi-Microphone System,” hereby incorporated by reference in its entirety.

In some embodiments, in addition to generating a set of weights via the beamforming circuit 506, the spatial filtering circuit 312 includes a post filter generator 510 configured to generate a filter (e.g., gain mask) for application to the output signal to provide further signal enhancement. For example, in one embodiment, the post filter generator 510 generates a gain mask via a Wiener filter algorithm that computes a set of frequency-based weights to be applied to the signal based on the power spectral density estimates generated by the signal classifier 508. In some embodiments, the signals from only one (or a subset) of the selected set of microphones 502 are used in calculating the gain mask. Such microphones may be selected based on characteristics of the sound signals generated by each of the subset of microphones 502 (e.g., signal-to-noise ratios, microphone occlusion). The microphones may be selected via any of the methods disclosed in U.S. Pat. No. 9,668,048 entitled “Contextual Switching of Microphones,” hereby incorporated by reference in its entirety. The post filter generator 510 may apply various constraints (e.g., gain limitations, smoothing) to the values that the gain mask filter can take. For more detail regarding operation of one possible post filter generator 510, see U.S. Pat. No. 9,143,857 entitled “Adaptively Reducing Noise While Limiting Speech Loss Distortion,” hereby incorporated by reference in its entirety.

The signal modifier 512 is configured to apply the gain mask generated via the post filter generator 510 to the output of the beamforming circuit to produce an audio output. For example, the signal output by the beamforming circuit 506 may be multiplied by the gain mask values, and the processed signal may be then be converted back to the time domain to produce a selectively enhanced output.

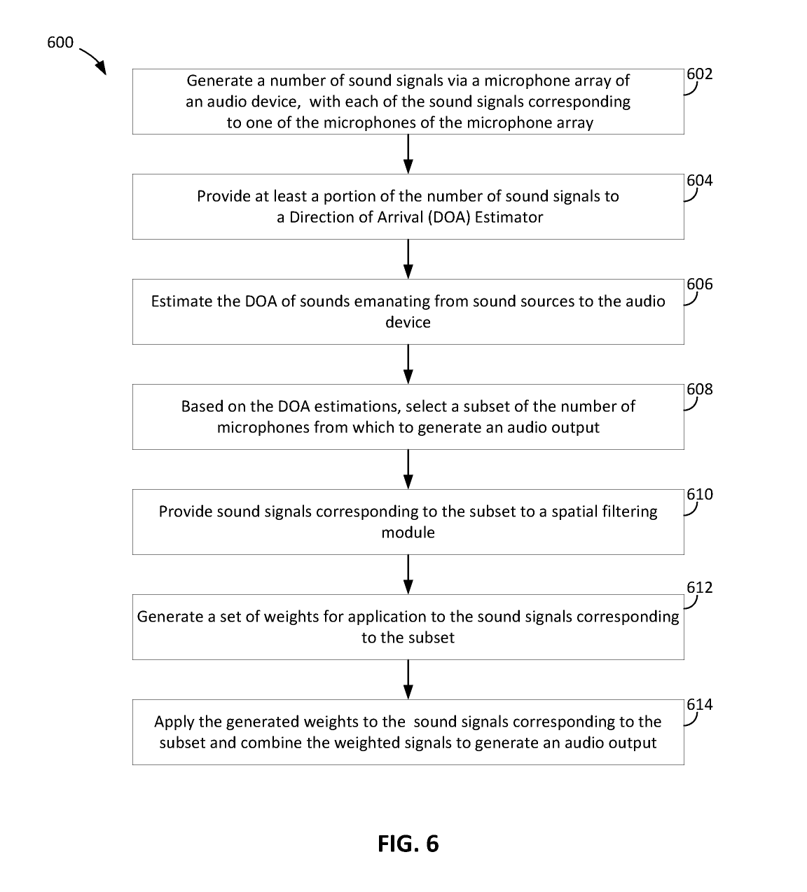

Referring now to FIG. 6, a flow diagram of a method 600 for generating an enhanced audio output from a number of sound signals generated via a microphone array is shown, according to an example embodiment. The method 600 may be executed by, for example, the audio processing system 108 described with respect to FIGS. 1-4.

In an operation 602, a number of sound signals are recorded via a microphone array of an audio device (e.g., the audio device 102). Each of the sound signals is recorded by one of the microphones of the microphone array. The microphone array may be of any suitable arrangement. For example, in one embodiment, the microphone array may be a circular arrangement of microphones, with each of the microphones being equally distributed around the circumference of a circle. In various embodiments, the microphone array includes an array of n microphones.

In some embodiments, each microphone in the microphone array is coupled to at least one multiplexer. In various embodiments, the audio device includes m multiplexers, where m is less than n. Each of the multiplexers includes input lines that are connected to at least two of the microphones. In some embodiments, each of the microphones is connected to every one of the multiplexers. The multiplexers may be associated with data analysis channels including components (e.g., analogue-to-digital converters) configured to place the sound signals into an analyzable form.

In an operation 604, at least a portion of the number of sound signals is provided to a DOA estimator (e.g., the DOA estimator 308). In this regard, the audio processing system 108 selects inputs from each of the multiplexers to provide to the DOA estimator. In some embodiments, sound signals associated with a number of the microphones are provided to the DOA estimator by each multiplexer. In such embodiments, the audio processing system 108 includes a time-matching filter configured to perform a time interpolation process to offset the time it takes to cycle the multiplexers between different input lines. In other embodiments, only a single microphone signal is provided to the DOA estimator by each multiplexer.

The portion of sound signals provided to the DOA estimator depends on the implementation. For example, in one embodiment, every sound signal generated at the operation 602 is provided to the DOA estimator. In other embodiments, a predetermined subset of the microphones of the microphone array is provided to the DOA estimator. The predetermined subset may be of an arrangement based on the overall geometry of the microphone array. In one embodiment, where the microphone array is a circular arrangement of microphones, sound signals from every other microphone are provided to the DOA estimator.

In an operation 606, the DOA estimator generates DOA estimates for various sound signals incident on the microphone array. For example, in one embodiment, the DOA estimator estimates the DOA based on an Eigen analysis of a covariance matrix between the provided sound signals. In various embodiments, such a process is performed on a frequency sub-band basis. As such, the audio processing system may decompose the sound signals into frequency subcomponents via a frequency analysis or transform circuit to generate a DOA estimate for a number of frequency sub-bands. Additionally, an averaging technique may then be employed to estimate the final DOA calculated across the different frequency sub-bands.

In an operation 608, the DOA estimate is used to select a subset of the microphones from which to generate an audio output. For example, the DOA estimates may be used to generate an observation signal for each frequency sub-band. Each of the number of microphone signals generated at 602 may be provided to a statistical subset selector. The statistical subset selector is configured to select a set of combinatorial weights that may be used to reconstruct the reference signal for a particular sub-band. For example, in one embodiment, the statistical subset selector uses the LASSO operator to generate a set of weights that includes a number of zero-valued weights and a number of nonzero-valued weights for each of the microphones. Thus, the statistical subset selector identifies a subset of microphones for each frequency sub-band. The subsets of microphones may vary in number depending on the frequency sub-band. In various embodiments, the statistical subset selector takes the union of all such subsets to select an overall subset of the microphones of the microphone array to use to construct an audio output.

In an operation 610, sound signals corresponding to the selected subset are provided to a spatial filtering circuit. In this regard, the audio processing system provides addresses to each of the multiplexers corresponding to the selected subset of microphones to communicably couple associated input lines to the spatial filtering circuit. In an operation 612, the spatial filtering circuit utilizes a beamforming algorithm (e.g., the least-mean square algorithm, MINT algorithm, Frost algorithm, MVDR algorithm, etc.) to generate a set of weights for each of the sound signals associated with the selected subset of microphones. In an operation 614, these weights are applied to the sound signals, and the weighted sound signals are combined to produce an audio output. As will be appreciated, any number of additional processing steps (e.g., gain mask filtering) may be applied to the output signal prior to using the output for its intended purpose (e.g., far-field voice recognition).

Preferred embodiments of a spatial filtering system are described herein. It should be understood that the illustrated embodiments are exemplary only, and should not be taken as limiting the scope of the invention.

What is claimed is:

1. An audio system, comprising:
an array of microphones comprising a plurality of microphones configured to generate a plurality of sound signals based on sound waves emanating from a sound source; and
an audio processing system comprising:
a direction of arrival (DOA) estimator configured to generate an estimation of a DOA of the sound waves emanating from the sound source based on the plurality of sound signals;
a statistical subset selector configured to select a subset of the plurality of microphones based on the estimation of the DOA; and
a spatial filter configured to modify and combine a set of sound signals associated with the selected subset of the plurality of microphones to produce an audio output associated with the sound source.

2. The audio system of claim 1, further comprising a plurality of data analysis channels, wherein each data analysis channel includes a multiplexer coupled with at least two of the plurality of microphones, wherein the audio device includes n microphones and m data analysis channels, wherein m is less than n.

3. The audio system of claim 2, wherein n is less than or equal to two times m.

4. The audio system of claim 2, wherein at least one of the plurality of data analysis channels includes an amplifier and an analog-to-digital converter.

5. The audio system of claim 2, wherein a microphone of the plurality of microphones is coupled to at least two multiplexers associated with at least two different data analysis channels.

6. The audio system of claim 2, wherein the audio processing system further includes an addressing circuit configured to selectively couple input lines of the multiplexers to the audio processing system.

7. The audio system of claim 2, wherein the addressing circuit is configured to:
periodically provide a first sequence of addresses to the multiplexers to enable execution of the DOA estimator and statistical subset selector; and
in response to the statistical subset selector selecting a subset of the plurality of microphones, provide a second sequence of addresses to the multiplexers to provide sound signals associated with the selected subset of microphones to the spatial filtering circuit.

8. The audio system of claim 7, wherein the first sequence of addresses includes an address associated with each of the plurality of microphones.

9. The audio system of claim 7, wherein the first sequence of addresses includes an address associated with a portion of the plurality of microphones, wherein the portion is predetermined based on a geometry of the array of microphones.

10. The audio system of claim 8, wherein the portion of the plurality of microphones corresponds with every other microphone of the plurality of microphones.

11. The audio system of claim 1, wherein the array of microphones includes at least one digital microphone.

12. A method of generating an audio output signal, comprising:
generating, by a microphone array associated with an audio device, a plurality of sound signals;
estimating, by an audio processing system coupled to the microphone array, a direction of arrival (DOA) of sounds emanating from a sound source;
selecting, by the audio processing system, a subset of microphones of the microphone array based on the estimated DOA;
providing, by the audio processing system, sound signals associated with the selected subset to a spatial filtering circuit to generate weights for each of the subset of microphones; and
combining, by the audio processing system, the weighted sound signals to generate an enhanced audio output.

13. The method of claim 12, wherein the estimating of the DOA is performed at a predetermined frequency to update the selected subset of microphones based on changes in relative position between the sound source and the audio device.

14. The method of claim 12, wherein the estimating of the DOA is performed via computation of a covariance matrix between a set of the plurality of sound signals.

15. The method of claim 14, wherein the set of the plurality of sound signals includes every one of the plurality of sound signals.

16. The method of claim 12, further comprising converting the plurality of sound signals to digital sound signals prior to estimating the DOA.

17. The method of claim 12, wherein estimating the DOA includes estimating a plurality of DOAs for a plurality of frequency sub-bands, wherein selecting the subset of microphones includes:
for an averaged value of the plurality of DOAs for plurality of frequency sub-band, generating a weight set, the weight set including a weight for each of the plurality of sound signals to reconstruct a reference signal generated based on the DOA, wherein the weight set includes a subset of zero-valued weights and a subset of nonzero-valued weights; and
identifying each microphone receiving a nonzero-valued weight for every one of the plurality of DOAs.

18. The method of claim 17, wherein generating the weight sets is performed using the least absolute shrinkage and selection operator.

19. The method of claim 12, further comprising:
generating, by the audio processing system, a multiplicative gain mask based on a sound signal generated by one of the selected set of microphones; and
applying, by the audio processing system, the multiplicative gain mask to the enhanced audio output.

20. The method of claim 12, further comprising providing, by the audio processing system, the enhanced audio output to a voice recognition system.
